(19) United States
(12) Patent Application Publication
(10) Pub. No.: US 2025/0323395 A1
(43) Pub. Date: Oct. 16, 2025

(54) CYLINDRICAL SECONDARY BATTERY

(71) Applicant: Samsung SDI Co., Ltd., Yongin-si (KR)

(72) Inventor: Dae Kyu Kim, Yongin-si (KR)

(73) Assignee: Samsung SDI Co., Ltd., Yongin-si (KR)

(21) Appl. No.: 19/012,730

(22) Filed: Jan. 7, 2025

(30) Foreign Application Priority Data
Apr. 12, 2024 (KR) 10-2024-0049136

(51) Int. Cl. H01M 50/567; H01M 10/04; H01M 10/0525; H01M 50/107; H01M 50/152; H01M 50/167; H01M 50/186; H01M 50/566

(52) U.S. Cl. CPC H01M 50/567; H01M 10/0468; H01M 50/107; H01M 50/152; H01M 50/167; H01M 50/186; H01M 50/566; H01M 10/0525

(57) ABSTRACT

Disclosed is a cylindrical secondary battery including an electrode assembly having a first electrode plate, a separator, and a second electrode plate; a case configured to receive the electrode assembly, wherein a lower end of the case is open, the case being electrically connected to the second electrode plate; a first current collector plate interposed between the electrode assembly and the case, the first current collector plate being electrically connected to the first electrode plate; a terminal extending through an upper surface portion of the case, the terminal having a lower end coupled to an upper surface of the first current collector plate; and a cap plate configured to seal the case, wherein the terminal includes a head located above the upper surface portion of the case, a fastening portion extending through the case, and a pressing portion located under the upper surface portion of the case.

### CROSS-REFERENCE TO RELATED APPLICATIONS

This present application claims priority to and the benefit under 35 U.S.C. § 119 (a)-(d) of Korean Patent Application No. 10-2024-0049136, filed on Apr. 12, 2024, in the Korean Intellectual Property Office, the entire disclosure of which is incorporated herein by reference.

### FIELD

Embodiments of the present disclosure relate to a cylindrical secondary battery.

### BACKGROUND

Generally, a cylindrical secondary battery may include a cylindrical electrode assembly, a cylindrical case configured to receive the electrode assembly and an electrolytic solution, and a cap assembly coupled to an open end of the case to seal the case and electrically connected to the electrode assembly, the cap assembly being electrically connected to the electrode assembly so as to serve as a means for electrical connection between an external configuration and the electrode assembly.

The information disclosed in this section is provided only for enhancement of understanding of the background of the present disclosure and therefore it may contain information that does not form the prior art.

### SUMMARY

Some embodiments of the present disclosure provide a cylindrical secondary battery configured such that the compression rate at which a pressing portion of a lower terminal presses a pressing insulating member is adjusted, whereby it is possible to prevent damage or leakage and to achieve sealing easily.

Some embodiments of the present disclosure provide a cylindrical secondary battery configured such that a terminal and a current collector plate are welded to each other through a terminal recess provided in a lower terminal outside a case, whereby it is possible to prevent welding debris from being generated in the case and to prevent an electrode assembly from being damaged by welding heat.

Some embodiments of the present disclosure provide a cylindrical secondary battery configured such that a terminal recess provided in a lower terminal is filled by an upper terminal, whereby an upper surface of a terminal is approximately flat, and therefore it is possible to prevent poor welding due to misalignment that may be caused by the terminal recess or to prevent an increase in resistance due to insufficient welding area while a plurality of secondary batteries is welded to each other via a busbar.

A cylindrical secondary battery according to some embodiments of the present disclosure includes an electrode assembly having a first electrode plate, a separator, and a second electrode plate, a case configured to receive the electrode assembly, wherein a lower end of the case is open, the case being electrically connected to the second electrode plate, a first current collector plate interposed between an upper surface of the electrode assembly and the case, the first current collector plate being electrically connected to the first electrode plate, a terminal extending through an upper surface portion of the case, the terminal having a lower end electrically and mechanically coupled to an upper surface of the first current collector plate, and a cap plate configured to seal the lower end of the case, wherein the terminal includes a head located above the upper surface portion of the case, a fastening portion extending through the case, and a pressing portion located under the upper surface portion of the case, and the pressing portion is bent about a bent portion and pressed in a state of overlapping in a form of two layers.

The pressing portion may have a plurality of corrugations extending from the center in which the fastening portion is located to the bent portion.

The pressing portion may be bent to have corrugations of a uniform thickness, and the distance between the corrugations may be constant.

The pressing portion may have 40 to 50 pitches, which corresponds to the number of corrugations.

The corrugation width of the pressing portion, which is the width between a high point and a low point of the corrugation, may be a same value as a thickness of the fastening portion.

The cylindrical secondary battery may further include a shaping portion located under the pressing portion, the shaping portion having a flat bottom plate and a side wall extending upward from an edge of the bottom plate, the side wall being coupled to a lower side of the pressing portion.

The corrugation width of the pressing portion, which is the width between the high point and the low point of the corrugation, may be less than 50% of the thickness of the side wall of the shaping portion.

The side wall may have a screw thread formed at an inner surface thereof.

The cylindrical secondary battery may further include a pressing insulating member interposed between the pressing portion and the case.

The pressing insulating member may extend farther outward than the pressing portion in plan, and a region of the pressing insulating member located above the pressing portion may be pressed such that the thickness of the region of the pressing insulating member located above the pressing portion is less than the thickness of a region of the pressing insulating member located outside the pressing portion.

The pressing insulating member may be pressed by the pressing portion so as to have a compression rate of 30% to 50%.

The terminal may include a lower terminal provided with a terminal recess having a predetermined depth from an upper surface thereof in a downward direction, the lower terminal including the head located above the upper surface portion of the case, the fastening portion extending through the case, and the pressing portion located under the upper surface portion of the case, and an upper terminal configured to fill the terminal recess of the lower terminal.

The first current collector plate may be welded to the lower terminal through the terminal recess outside the lower terminal in the state in which an upper surface of the first current collector plate is in contact with a lower surface of the lower terminal such that a weld bead is located in the terminal recess.

The upper terminal may include an approximately flat flange and a coupling portion extending downward from the center of the flange, the coupling portion having a screw thread provided at an outer surface thereof.

The fastening portion may have a screw thread provided at an inner surface thereof, the screw thread of the fastening portion being screw-engaged with the screw thread of the coupling portion.

The flange of the upper terminal and an upper surface of the lower terminal may be in a same plane.

The head of the lower terminal may be provided with a ring-shaped stepped groove extending from an upper surface thereof in a downward direction, the flange of the upper terminal being inserted into and seated in the stepped groove.

A lower surface of the coupling portion may be spaced apart from a lower surface of the terminal recess.

The cylindrical secondary battery may further include a first gasket interposed between the terminal and the case.

The cylindrical secondary battery may further include a second gasket interposed between the case and the cap plate, wherein the cap plate may be non-polarized.

### BRIEF DESCRIPTION OF THE DRAWINGS

The accompanying drawings, which are incorporated in this specification, illustrate exemplary embodiments and serve to further illustrate the technical ideas of the present disclosure in conjunction with the detailed description of exemplary embodiments that follows, and the present disclosure is not to be construed as limited to what is shown in such drawings. In the drawings:

FIG. 1 is a perspective view of a cylindrical secondary battery, according to some embodiments of the present disclosure;

FIG. 2 is a sectional view of the cylindrical secondary battery shown in FIG. 1;

FIG. 3 is an enlarged sectional view showing a part denoted by section 3 in FIG. 2;

FIG. 4 is an enlarged view showing a lower terminal of FIG. 3 before shaping;

FIG. 5 is a sectional view showing a pressing portion of the lower terminal of FIG. 4;

FIG. 6 is a sectional view showing an example in which the lower terminal is shaped by a shaping tool; and

FIG. 7 is an enlarged sectional view showing another example of a position of a pressing insulating member in the cylindrical secondary battery according to some embodiments of the present disclosure.

### DETAILED DESCRIPTION

Hereinafter, exemplary embodiments of the present disclosure will be described in detail with reference to the accompanying drawings.

Embodiments of the present disclosure are provided to more fully illustrate the present disclosure to a person having ordinary skill in the art. The following embodiments may be modified in various other forms, and the scope of the present disclosure is not limited to the following embodiments. The embodiments are provided to make the present disclosure more complete and to convey the idea of the present disclosure fully to those skilled in the art.

In the accompanying drawings, the thickness or size of each layer is exaggerated for simplicity and clarity of description and the same reference symbols in the drawings refer to the same elements. As used herein, the term “and/or” includes any one of the enumerated items and any combination of one or more thereof. As used herein, the term “connected” refers not only to direct connection between members A and B but also to indirect connection between members A and B with member C interposed therebetween.

The terms used in the specification are intended to describe specific embodiments and are not intended to limit the present disclosure. As used herein, singular forms may include plural forms, unless the context clearly indicates otherwise. As used herein, the terms “comprise” (or “include”) and/or “comprising” (or “including”) are intended to specify the presence of stated figures, numbers, steps, operations, members, elements, and/or groups thereof and do not exclude the presence or addition of one or more other figures, numbers, steps, operations, members, elements, and/or groups.

While terms such as first and second are used herein to describe various members, parts, regions, layers, and/or portions, the members, the parts, the regions, the layers, and/or the portions are not to be limited by the terms. The terms are used only to distinguish one member, one part, one region, one layer, or one portion from another member, another part, another region, another layer, or another portion. Thus, a first member, a first part, a first region, a first layer, or a first portion hereinafter described may refer to a second member, a second part, a second region, a second layer, or a second portion without departing from the teachings of the present disclosure.

Terms related to space, such as “beneath,” “below,” “lower,” “above,” and “upper,” may be utilized to facilitate understanding of one element or feature shown in the drawings as different from another element or feature. The terms related to space are intended to facilitate understanding of the present disclosure in various states of process or use and are not intended to limit the present disclosure. For example, if an element or feature in a figure is inverted, an element or feature described as “beneath” or “below” becomes “above” or “upper.” Thus, “beneath” is a concept that encompasses “above” or “below”. The term “approximately” may be used to mean within ±5% of a target value in some embodiments, and the term “approximately” may include the target value.

Exemplary embodiments of the present disclosure will now be described in detail with reference to the accompanying drawings such that a person having ordinary skill in the art to which the present disclosure pertains can easily practice the present disclosure.

Throughout the specification, parts having similar construction and operation are designated by the same reference symbols. If a part is said to be electrically coupled to another part, this includes not only the case in which the parts are directly connected to each other but also the case in which the parts are connected to each other via a further part.

As discussed herein, a cylindrical secondary battery may include a cylindrical electrode assembly, a cylindrical case configured to receive the electrode assembly and an electrolytic solution, and a cap assembly coupled to an open end of the case to seal the case and electrically connected to the electrode assembly, the cap assembly being electrically connected to the electrode assembly so as to serve as a means for electrical connection between an external configuration and the electrode assembly.

In a battery module in which a plurality of cylindrical secondary batteries is connected to each other, busbars must be connected to the top and bottom of each of the secondary batteries, resulting in a complex structure and long process time.

In order to solve problems associated with the aforementioned cases, the can may be provided with a terminal hole in the other end thereof opposite the open end, and a rivet terminal of a positive electrode may be coupled in the terminal hole such that the rivet terminal is insulated from the can. This structure may allow the busbars to be provided on the same surfaces of the secondary batteries, whereby the busbars and the secondary batteries may be easily connected to each other in the battery module.

The rivet terminal of the positive electrode may be coupled to the can by riveting. However, it may not be easy to adjust the degree to which the rivet terminal is pressed, whereby cracks may occur due to excessive riveting or sealing force may decrease due to non-pressing.

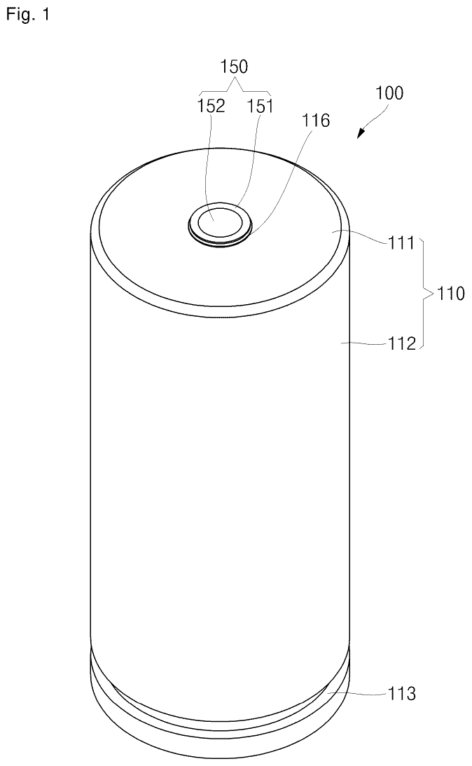

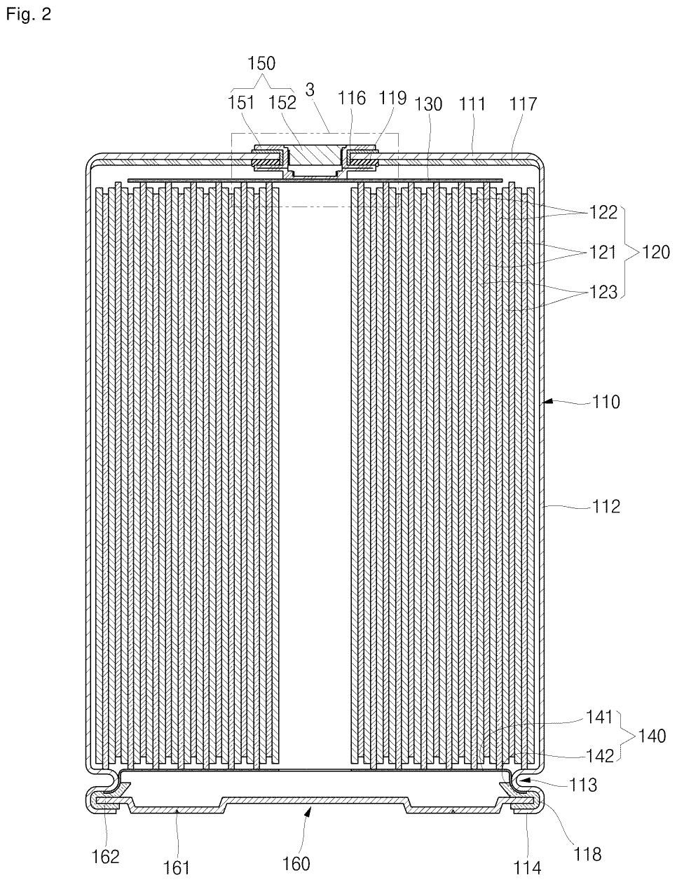

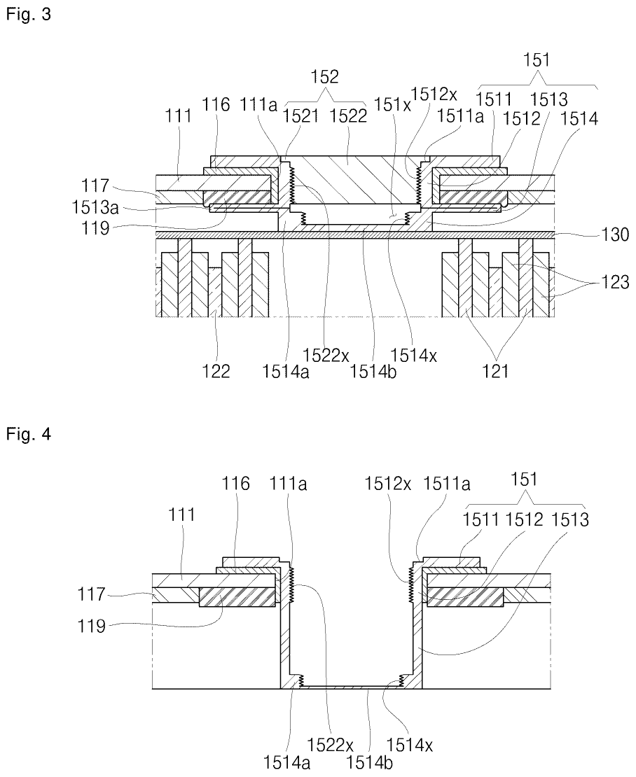

FIG. 1 is a perspective view of a cylindrical secondary battery 100 according to some embodiments of the present disclosure. FIG. 2 is a sectional view of the cylindrical secondary battery 100 shown in FIG. 1, taken in a longitudinal direction. FIG. 3 is an enlarged sectional view showing a part denoted by section 3 in FIG. 2. Hereinafter, the cylindrical secondary battery 100 will be described with reference to FIGS. 1 to 3.

As shown in FIGS. 1 and 2, the cylindrical secondary battery 100 according to some embodiments of the present disclosure may include a case 110, an electrode assembly 120 received in the case 110, a terminal 150 coupled to a terminal hole provided in one end of the case 110, and a cap plate 160 configured to seal an opening in the other end of the case 110.

The case 110 may include a circular upper surface portion 111 and a side surface portion 112 extending downward from an edge of the upper surface portion 111 by a predetermined length. The upper surface portion 111 and the side surface portion 112 of the case 110 may be integrally formed. The case 110 may further include a round-shaped bent portion provided between the upper surface portion 111 and the side surface portion 112.

The circular upper surface portion 111 may have a flat circular shape and may have a terminal hole 111a formed through the center thereof. The terminal 150 may be inserted into and coupled to the terminal hole 111a of the upper surface portion 111. A first gasket 116 for sealing and electrical insulation may be interposed between the terminal hole 111a and the terminal 150. The first gasket 116 may block contact between the terminal 150 and the case 110 in order to electrically isolate the terminal and the case from each other. The first gasket 116 may seal the terminal hole 111a of the upper surface portion 111 of the case 110. The first gasket 116 may be made of a resin material such as polyethylene (PE), polypropylene (PP), or polyethylene terephthalate (PET). The first gasket 116 may extend along the upper surface portion 111 of the case 110, and may be interposed in the region in which the terminal 150 and the upper surface portion 111 overlap each other in plan. The first gasket 116 may be provided only in a region corresponding to the terminal hole 111a, and a separate upper insulating member may be interposed in the region in which the terminal 150 and the upper surface portion 111 overlap each other in plan. Hereinafter, the configuration in which the first gasket 116 extends between the terminal hole 111a and the terminal 150 and between the terminal 150 and an upper side of the upper surface portion 111 of the case 110 will be described for simplicity of description.

The case 110 may further include an inner insulating member 117 configured to cover an inner surface of the upper surface portion 111. The inner insulating member 117 may be attached to the inner surface of the upper surface portion 111 by coating or adhesion. The inner surface of the upper surface portion 111 may be a surface that faces an upper surface of the electrode assembly 120, and may be a lower surface of the upper surface portion 111. The inner insulating member 117 may prevent contact between the upper surface portion 111 of the case 110 and a first electrode plate 121 of the electrode assembly 120. In another example, the inner insulating member 117 may extend to an inner surface of the bent portion. The inner insulating member 117 may be configured to cover both the inner surface of the upper surface portion 111 and the inner surface of the bent portion, or may be configured to cover only the inner surface of the upper surface portion 111.

During the manufacturing process of the cylindrical secondary battery 100, the bottom of the case 110 may be open. During the manufacturing process of the cylindrical secondary battery 100, therefore, the electrode assembly 120 may be inserted into the case 110 through the open bottom of the case along with an electrolytic solution. In this case, the electrolytic solution and the electrode assembly 120 may be inserted into the case 110 in the state in which the open bottom of the case faces upward. After the electrolytic solution and the electrode assembly 120 are inserted into the case 110, the cap plate 160 may be coupled to a lower end of the case to seal the interior of the case 110. The electrolytic solution may allow lithium ions to move between a positive first electrode plate 121 and a negative second electrode plate 122 constituting the electrode assembly 120. The electrolytic solution may be a non-aqueous organic electrolytic solution, which is a mixture of a lithium salt and a high-purity organic solvent. The electrolytic solution may be a polymer using a polyelectrolyte or a solid electrolyte; however, the present disclosure is not limited thereto.

The case 110 may be made of steel, a steel alloy, aluminum (AI), an aluminum alloy, or an equivalent thereto; however, the present disclosure is not limited thereto. The case 110 may have a crimping portion 114 formed at an end of the side surface portion 112, the crimping portion being bent so as to wrap around the cap plate 160. A second gasket 118 may be interposed between the crimping portion 114 and the cap plate 160. The second gasket 118 may block contact between the cap plate 160 and the case 110 to electrically separate the cap plate 160 and the case 110 from each other. The second gasket 118 may seal (provide sealing) between the case 110 and the cap plate 160.

In some examples, the case 110 may further include a beading portion 113 formed above the cap plate 160 so as to be recessed in an inward direction of the case 110. At the lower end of the case 110, the inwardly recessed beading portion 113 may be provided above the cap plate 160, and the crimping portion 114 may be bent so as to cover the lower side of the cap plate 160. After the electrode assembly 120 is inserted into the case 110 through the open bottom of the case, the beading portion 113 may be formed to prevent the electrode assembly 120 from being separated from the case 110.

The electrode assembly 120 may include a first electrode plate 121, a second electrode plate 122, and a separator 123. The first electrode plate 121 may be a positive electrode plate, and the second electrode plate 122 may be a negative electrode plate. In some embodiments, the first electrode plate 121 may be a negative electrode plate, and the second electrode plate 122 may be a positive electrode plate. Hereinafter, the case in which the first electrode plate 121 is a positive electrode plate and the second electrode plate 122 is a negative electrode plate will be described for simplicity of description.

The first electrode plate 121 may have a positive electrode active material, such as a transition metal oxide, formed on at least one surface of flat metal foil made of aluminum (Al) by coating. A positive electrode uncoated portion coated with no positive electrode active material may be provided at an upper end of the first electrode plate 121. The positive electrode uncoated portion may protrude in an upward direction of the electrode assembly 120. The positive electrode uncoated portion of the first electrode plate 121 may protrude farther in the upward direction than the second electrode plate 122 and the separator 123.

The second electrode plate 122 may have a negative electrode active material, such as graphite or carbon, formed on at least one surface of flat metal foil made of copper (Cu) or nickel (Ni) by coating. A negative electrode uncoated portion coated with no negative electrode active material may be provided at a lower end of the second electrode plate 122. The negative electrode uncoated portion may protrude in a downward direction of the electrode assembly 120. The negative electrode uncoated portion of the second electrode plate 122 may protrude farther in the downward direction than the first electrode plate 121 and the separator 123.

The separator 123 may be made of polyethylene (PE) or polypropylene (PP); however, the present disclosure is not limited thereto. The separator may prevent electrical short circuit between the first electrode plate 121 and the second electrode plate 122 and may allow only migration of lithium ions.

After the first electrode plate 121, the second electrode plate 122, and the separator 123 are stacked, the first electrode plate, the second electrode plate, and the separator are wound from winding leading edges thereof, whereby the electrode assembly may be wound into an approximately columnar shape. The positive electrode uncoated portion having no positive electrode active material of the first electrode plate 121 may protrude in the upward direction of the electrode assembly 120, and the negative electrode uncoated portion having no negative electrode active material of the second electrode plate 122 may protrude in the downward direction of the electrode assembly 120. The outermost positive electrode uncoated portion may not protrude in the upward direction of the electrode assembly 120, and the outermost negative electrode uncoated portion may not protrude in the downward direction of the electrode assembly 120. The electrode assembly 120 may be provided at each of the uppermost side and the lowermost side thereof with a concave step. Consequently, contact between the electrode assembly 120 and the case 110 may be prevented even without the inner insulating member 117 being formed at the bent portion of the case 110.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is AI, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material may be in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto. The organic material and the inorganic material may be mixed in one coating layer or may be in the form of a coating layer containing an organic material and a coating layer containing an inorganic material that are laminated on each other.

A first current collector plate 130 may be a circular metal plate having a shape corresponding to the upper surface of the electrode assembly 120. The planar size of the first current collector plate 130 may be equal to or less than the size of the upper surface of the electrode assembly 120. The first current collector plate 130 may be made of aluminum (Al). The first current collector plate 130 may be fixed and electrically connected to the first electrode plate 121 exposed at the top of the electrode assembly 120 by welding such that a lower surface of the first current collector plate is in contact with the upper surface of the electrode assembly 120. The first current collector plate may be interposed between the upper surface and the case. The first current collector plate 130 may be fixed and electrically connected to the terminal 150 by welding such that an upper surface of the first current collector plate is in contact with a lower surface of the terminal 150. The terminal may extend through an upper surface portion of the case and may have a lower end electrically and mechanically coupled to the upper surface of the first current collector plate. The first current collector plate 130 may be a path for current flow between the first electrode plate 121 of the electrode assembly 120 and the terminal 150. The first current collector plate 130 may be welded to the electrode assembly 120, may be received in the case 110, and may be welded to the terminal 150. The thickness of the first current collector plate 130 may be less than the lower thickness of a lower terminal 151 of the terminal 150, a description of which will follow, in order to improve weldability.

A second current collector plate 140 may include a circular flat portion 141 corresponding to the lower surface of the electrode assembly 120 and an extension portion 142 extending downward from an edge of the flat portion 141. An upper surface of the flat portion 141 may be in contact with the lower surface of the electrode assembly 120. The flat portion 141 may be fixed and electrically connected to the second electrode plate 122 exposed at the bottom of the electrode assembly 120 by welding such that the upper surface of the flat portion is in contact with the lower surface of the electrode assembly 120.

The extension portion 142 may extend downward from an edge of the flat portion 141. In some examples, a plurality of extension portions 142 may be disposed spaced apart from each other along the edge of the flat portion 141. The extension portions 142 may be disposed so as to be symmetrical to each other around the flat portion 141; however, the present disclosure is not limited thereto. The extension portion 142 may be bent and may extend downward from the edge of the flat portion 141. The extension portion 142 may be in contact with an inner surface of the side surface portion 112 of the case 110. The inner surface may be an inside surface of the case 110. An end of the extension portion 142 may be located between the side surface portion 112 of the case 110 and the second gasket 118. If the beading portion 113 is provided at the case 110, the extension portion 142 may be in contact with and may be coupled to the beading portion 113. In some examples, the extension portion 142 may be coupled to the inner surface of the side surface portion 112 of the case 110 or the inner surface of the beading portion 113 by welding in a state of being in contact therewith. The second current collector plate 140 may be a path for current flow between the second electrode plate 122 of the electrode assembly 120 and the case 110 (e.g., such that the case is electrically connected to the second electrode plate). The case 110 may be a negative electrode terminal. In some examples, the second current collector plate 140 may have a hole formed through the center of the flat portion 141 from an upper surface to a lower surface thereof, and the electrolytic solution may be easily injected into the electrode assembly 120 through the hole.

The terminal 150 may be inserted into the terminal hole 111a formed in the upper surface portion 111 of the case 110, and may be brought into contact with and electrically connected to the first current collector plate 130. The terminal 150 may be electrically connected to the first electrode plate 121 of the electrode assembly 120 via the first current collector plate 130. The terminal 150 may be a positive electrode terminal. The terminal 150 and the case 110 may have different polarities. The terminal 150 may be made of a material identical or similar to the material of the first current collector plate 130 and the first electrode plate 121 of the electrode assembly 120.

The terminal 150 may include a lower terminal 151 and an upper terminal 152. The lower terminal 151 may have a terminal recess 151x extending downward from the center of an upper surface thereof with a predetermined depth. The lower terminal 151 may include a head 1511, a fastening portion 1512, a pressing portion 1513, and a shaping portion 1514 provided sequentially in a direction from the outside to the inside of the case 110.

First, the head 1511 may be an approximately circular flat plate exposed at the top of the case 110 and may have a hole formed through the center thereof. The hole may be a part of the terminal recess 151x. The head 1511 may be approximately ring-shaped in plan. The head 1511 may be located above the upper surface portion 111. The head 1511 may have a region overlapping the upper surface portion 111 in plan. An insulating member may be interposed between the head 1511 and the upper surface portion 111 to block electrical contact therebetween.

For example, the first gasket 116 may be disposed in the region in which the head 1511 and the upper surface portion 111 overlap each other in plan in order to block electrical contact therebetween. The first gasket 116 may also be interposed between the fastening portion 1512 and the terminal hole 111a of the case 110. In this case, an upper end of the first gasket 116 may extend farther outward than the head 1511. The first gasket 116 may be interposed between the lower terminal 151 and the case 110 to electrically insulate the lower terminal 151 and the case 110 from each other. The first gasket 116 may be in contact with the upper surface of the upper surface portion 111 of the case 110. A lower end of the first gasket 116 may be in contact with a pressing insulating member 119.

The head 1511 may have a ring-shaped stepped groove 1511a extending downward from the upper surface thereof. A central region of the head 1511 may be thinner than other regions of the head 1511 due to the stepped groove 1511a.

The fastening portion 1512 may extend inwardly of (e.g., through) the case 110 from the central region of the head 1511. The fastening portion 1512 may have an approximately cylindrical shape, wherein an upper end of the fastening portion may be connected to the head 1511 and a lower end of the fastening portion may be connected to an upper end of the pressing portion 1513. The head 1511 may extend outwardly of (relative to) the upper surface portion 111 from the upper end of the fastening portion 1512. The fastening portion 1512 may have a uniform thickness. The fastening portion 1512 may be provided with a screw thread 1512x at an inner surface thereof. The inner surface may be a surface located in the cylindrical fastening portion 1512. The inner surface of the fastening portion 1512 may be a part of the terminal recess 151x. The screw thread 1512x of the fastening portion 1512 may be provided for screw engagement with the upper terminal 152.

The pressing portion 1513 may be provided at a lower end of the fastening portion 1512. The pressing portion 1513 may be located under the upper surface portion 111 of the case 110. The pressing portion 1513 may be pressed to press the lower side of the central region of the upper surface portion 111 of the case 110. A pressing insulating member 119 may further be interposed between the pressing portion 1513 and the central region of the upper surface portion 111 of the case 110. The pressing insulating member 119 may be in contact with the inner insulating member 117. The pressing insulating member 119 may be in contact with an end of the inner insulating member 117. The pressing insulating member 119 and the inner insulating member 117 may be interposed between the pressing portion 1513 and the upper surface portion 111 of the case 110 so as not to overlap each other in plan. The thickness of the region of the pressing insulating member 119 located above the pressing portion 1513 may be less than the thickness of the remaining region of the pressing insulating member 119 located outside the pressing portion. As the pressing insulating member 119 is pressed by the pressing portion 1513, the thickness of the pressing insulating member 119 may be changed. The pressing insulating member 119 may be made of a resin material such as polyethylene (PE), polypropylene (PP), or polyethylene terephthalate (PET).

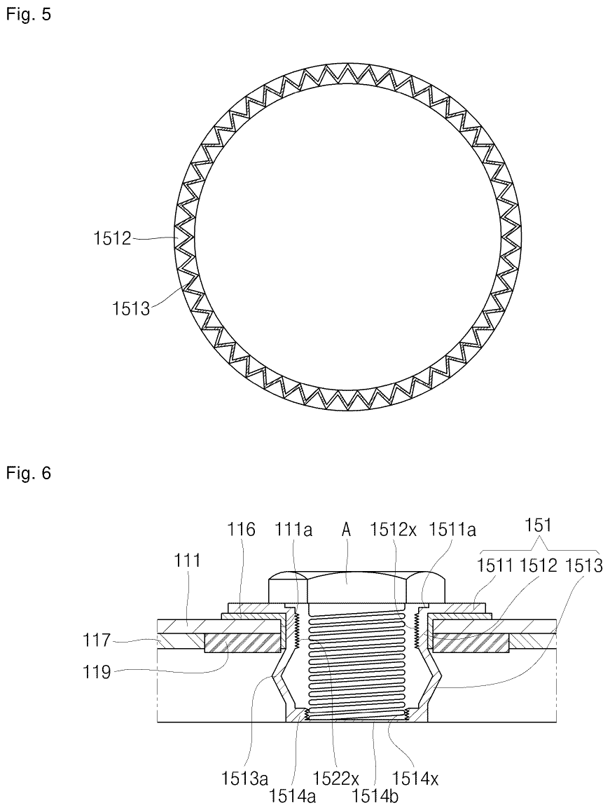

FIG. 4 is an enlarged view showing the lower terminal 151 of FIG. 3 before shaping of the pressing portion 1513. FIG. 5 is a sectional view of the pressing portion 1513 of FIG. 4 taken in a horizontal direction. Hereinafter, the structure of the lower terminal 151 before the pressing portion 1513 is shaped and shaping of the pressing portion 1513 will be described with reference to FIGS. 4 and 5.

The pressing portion 1513 may have an approximately corrugated tubular shape before pressing. The pressing portion 1513 may have a plurality of corrugations extending in a first direction x, which is the height direction of the electrode assembly 120. The pressing portion 1513 may have equally spaced corrugations (e.g., the distance between the corrugations is constant) and may be bent to have corrugations of a uniform thickness. The pressing portion 1513 may have 40 to 50 pitches, which is/corresponds to the number of corrugations. If the pitches of the pressing portion 1513 are less than 40, the width of each pitch may be increased, whereby the strength of the pressing portion 1513 may increase, making it difficult to press the pressing portion 1513. If the pitches of the pressing portion 1513 exceed 50, it may be difficult to form the pressing portion 1513, and the strength of the pressing portion 1513 may increase due to an increase in the number of pitches. The corrugation width of the pressing portion 1513, which is the width between the high and low points of the corrugation, may be the same value as the thickness of the fastening portion 1512. The corrugation width may be the width for each corrugation.

The shaping portion 1514 may be an approximately flat plate and may be connected to a lower side of the pressing portion 1513 (e.g., located under the pressing portion). The shaping portion 1514 may have a recess formed in the center thereof so as to extend from an upper surface thereof in a downward direction, and the recess may be a part of the terminal recess 151x. The terminal recess 151x may be a recess extending to a part of the top of the shaping portion 1514 through the head 1511, the fastening portion 1512, and the pressing portion 1513. The shaping portion 1514 may include a bottom plate 1514b formed so as to be roughly flat by the recess and a cylindrical side wall 1514a extending upward from an edge of the flat bottom plate 1514b. An upper end of the side wall 1514a of the shaping portion 1514 may be coupled to a lower side of the pressing portion 1513. The thickness of the side wall 1514a of the shaping portion 1514 may be greater than the corrugation width of the pressing portion 1513 and the thickness of the fastening portion 1512. The corrugation width of the pressing portion 1513 may be less than 50% of the width of the shaping portion 1514 (e.g., a thickness of the side wall of the shaping portion). A screw thread 1514x may be provided at an inner surface of the side wall 1514a of the shaping portion 1514. The inner surface of the shaping portion 1514 may be a part of the terminal recess 151x. The inner surface of the shaping portion 1514 may be closer to the center of the lower terminal 151 than the inner surface of the fastening portion 1512 and the inner surface of the pressing portion 1513. If the shaping portion 1514 is shaped in the state in which a shaping tool A is coupled to the screw thread 1514x, therefore, damage to the pressing portion 1513 and the fastening portion 1512 due to contact with the shaping tool A may be prevented.

The screw thread 1514x of the shaping portion 1514 may be coupled to the shaping tool to press the pressing portion 1513 of the lower terminal 151.

After the shaping tool A is coupled to the screw thread 1514x of the shaping portion 1514 of the lower terminal 151, as shown in FIG. 6, the pressing portion 1513 may be deformed and pressed by rotation of the shaping tool A, whereby the pressing portion may be shaped. An approximate center of the pressing portion 1513 in the first direction x may be bent outward by the shaping tool A to provide a bent portion 1513a. Subsequently, the bent portion 1513a of the pressing portion 1513 may be located outward in plan by the shaping tool A, and an upper end and a lower end of the pressing portion may be adjacent to each other. Subsequently, the pressing portion 1513 may be bent and pressed by the shaping tool A. The pressing portion 1513 may be pressed toward the upper surface portion 111 of the case 110. The bending portion 1513a may be bent, and the upper and the lower end of the pressing portion 1513 may be adjacent to each other, whereby the pressing portion 1513 may be compressively deformed (compressively shaped) to press the pressing insulating member 119. The lower terminal 151 may adjust the degree to which the pressing portion 1513 presses the pressing insulating member 119. The pressing portion 1513 may press the pressing insulating member 119 to seal the terminal hole 110a of the case 110. The pressing portion 1513 may be bent about the bent portion 1513a and may be pressed in a state of overlapping/may overlap in (a form of/to form) two layers.

Referring to Table 1, test data about sealing based on the initial thickness of the pressing insulating member 119, the thickness of the pressing insulating member 119 after being pressed by the pressing portion 1513, and the compression rate are shown. The compression rate can be calculated as (initial thickness-thickness after pressing)/(initial thickness). The initial thickness of the pressing insulating member 119 may be 5 mm.

TABLE 1

| Experimental | Thickness | | Compression | |
|---|---|---|---|---|
| example | after pressing | | rate | Sealing |
| 1 | 0.1 | mm | 80% | X |
| 2 | 0.2 | mm | 60% | X |
| 3 | 0.25 | mm | 50% | ◯ |
| 4 | 0.3 | mm | 40% | ◯ |
| 5 | 0.35 | mm | 30% | ◯ |
| 6 | 0.4 | mm | 20% | X |
| 7 | 0.5 | mm | 0% | X |

It can be seen from the results of Experimental examples 3 to 5 shown in Table 1 that, if the compression rate of the pressing insulating member 119 is reduced to about 30% to 50% by pressing of the pressing portion 1513, sealing is achieved (indicated by O).

In the case of Experimental examples 1 and 2, if the compression rate of the pressing insulating member 119 exceeds 50%, without wishing to be bound by any particular theory, the pressing insulating member 119 may be excessively pressed and leakage may occur due to cracking. If the compression rate of the pressing insulating member 119 is less than 30%, as in Experimental examples 6 and 7, without wishing to be bound by any particular theory, leakage may occur due to poor tight contact between the pressing portion 1513 and the pressing insulating member 119.

As such, the pressing insulating member 119 pressed by the pressing portion 1513 may have a reduced thickness compared to before the pressing insulating member is pressed, whereby the thickness of the part of the pressing insulating member 119 located on the outside in plan (extending farther outward than the pressing portion in plan) may be greater than the thickness of the part of the pressing insulating member pressed by the pressing portion 1513. The pressing portion 1513 may press the pressing insulating member 119 at a desired compression rate to seal between the lower terminal 151 and the case 110.

The pressing portion 1513 may be shaped, whereby the corrugations may extend parallel to the upper surface of the case 110. The corrugations of the pressing portion 1513 may extend in an outward direction. The corrugations of the pressing portion 1513 may be bent and pressed and may extend unevenly, with the bent center extending outwardly while the corrugations are unfolded. The pressing portion 1513 may be located farther outward in plan than the upper end and the lower end thereof connected to the shaping portion 1514 and the fastening portion 1512. The pressing portion may have a plurality of corrugations extending from a center (portion in which the fastening portion is located) to the bent portion.

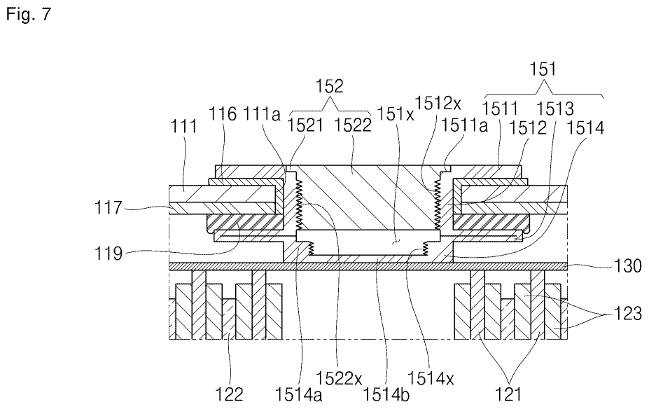

In another example, the pressing insulating member 119 may be located under the inner insulating member 117, as shown in FIG. 7. In this case, the upper surface of the pressing insulating member 119 may be in tight contact with the lower surface of the inner insulating member 117. The pressing insulating member 119 may be interposed between the case 110 and the pressing portion 1513 of the lower terminal 151 so as to overlap the inner insulating member 117 in plan.

The diameter of each of the head 1511 and the pressing portion 1513 of the lower terminal 151 may be greater than the diameter of the remaining part of the lower terminal 151. The head 1511 and the pressing portion 1513 of the lower terminal 151 may overlap the case 110 in plan. The lower terminal 151 may be pressed in the state in which the case 110 is interposed between the head 1511 and the pressing portion 1513, whereby a seal may be formed between the case 110 and the lower terminal 151. An insulating member may be interposed between the lower terminal 151 and the case 110 to insulate the lower terminal 151 and the case 110 from each other. Although the insulating member is shown as the pressing insulating member 119 and the first gasket 116, the pressing insulating member 119 may be integrally formed with the first gasket 116. In this case, a separate insulating member may be provided between the head 1511 of the lower terminal 151 and the upper surface of the case 110.

The lower terminal 151 may be welded to the first current collector plate 130 through the terminal recess 151x in the state in which a lower surface of the bottom plate 1514b of the shaping portion 1514 is in contact with the first current collector plate 130 (e.g., in contact with the upper surface thereof). The lower terminal 151 may be provided with the terminal recess 151x, whereby welding between the lower terminal 151 and the first current collector plate 130 outside the lower terminal 151 may be performed. Consequently, it is possible to prevent welding debris from being generated in the case 110 and to prevent the electrode assembly 120 from being damaged by welding heat. Because the lower terminal 151 is provided with the terminal recess 151x, a weld bead may be located in the recess of the shaping portion 1514 in the terminal recess 151x even if the lower terminal 151 and the first current collector plate 130 are welded to each other outside the lower terminal 151. The upper inner diameter of the terminal recess 151x may be greater than the lower inner diameter of the terminal recess 151x.

The upper terminal 152 may be inserted into and coupled to the terminal recess 151x of the lower terminal 151. The upper terminal 152 may include an approximately flat flange 1521 and a coupling portion 1522 extending downward from the center of the flange 1521.

The flange 1521 may be inserted into and seated in the stepped groove 1511a of the head 1511 of the lower terminal 151. An upper surface of the flange 1521 may be in a (the) same plane as the upper surface of the head 1511 of the lower terminal 151.

The coupling portion 1522 may be inserted into the terminal recess 151x provided in the head 1511. The coupling portion 1522 may have a screw thread 1522x formed at the outer surface thereof, which may be screw-engaged with the screw thread 1512x of the fastening portion 1512 of the lower terminal 151 at the inner surface thereof. A lower surface of the coupling portion 1522 may be spaced apart from the bottom plate 1514b of the shaping portion 1514 (e.g., a lower surface of the terminal recess).

The upper terminal 152 may be coupled to the terminal recess 151x of the lower terminal 151, whereby the terminal 150 may have a flat upper surface.

The cap plate 160 may be a circular metal plate, and may be coupled to the lower end of the case 110. A lower surface of the cap plate 160 may be exposed to the outside. The cap plate 160 may be coupled to the lower end of the case 110 in the state in which the second gasket 118 is interposed therebetween, whereby electrical connection between the cap plate 160 and the case 110 may be prevented. The cap plate 160 may not be electrically connected to the positive electrode or the negative electrode of the electrode assembly 120, and therefore cap plate 160 may have no electrical polarity (non-polarized).

An edge region 162 of the cap plate 160 may be fixed by the crimping portion 114 of the case 110. The cap plate 160 may be seated on the second gasket 118 such that the second gasket 118 is disposed under the case 110. Subsequently, the crimping portion 114 of the case 110 may be bent inwardly of the cap plate 160 to press the second gasket 118, whereby the cap plate 160 and the case 110 may be coupled to each other. The second gasket 118 may be made of a resin material such as polyethylene (PE), polypropylene (PP), or polyethylene terephthalate (PET). The second gasket 118 may be pressed to seal between the case 110 and the cap plate 160, and may prevent separation of the cap plate 160 from the case 110. The top of the second gasket 118 may be interposed between the case 110 and the cap plate 160. A lower end of the second gasket 118 may protrude farther in toward the center of the cap plate 160 than the crimping portion 114.

The cap plate 160 may include an outwardly protruding region, and a vent 161 configured to be opened at a predetermined pressure may be provided in the protruding region of the cap plate 160. The vent 161 may have a smaller thickness than the remaining region of the cap plate 160. The vent 161 may be a notch formed upward from a lower surface of the cap plate 160. The protruding region may have an approximately ring shape in plan so as to be spaced apart from the edge region of the cap plate 160 in contact with the second gasket 118.

If excessive pressure is generated in the case 110 of the cylindrical secondary battery 100, the vent may rupture to release the excessive pressure. The vent 161 of the cap plate 160 may be spaced apart from the center and formed to have a ring shape in plan. In another example, the vent 161 may have at least one pattern having a straight or curved shape in plan. The thickness of the vent 161 may be less than the thickness of the remaining region of the cap plate 160.

In the cylindrical secondary battery 100, the compression rate at which the pressing portion 1513 of the lower terminal 151 presses the pressing insulating member 119 may be adjusted, whereby it is possible to prevent damage or leakage due to excessive pressing or non-pressing, respectively, and to achieve sealing easily.

In the cylindrical secondary battery 100, the terminal 150 and the first current collector plate 130 may be welded to each other through the terminal recess 151x provided in the lower terminal 151 outside the case 110. In the cylindrical secondary battery 100, therefore, it is possible to prevent welding debris from being generated in the case 110 or to prevent the electrode assembly 120 from being damaged by welding heat.

The cylindrical secondary battery 100 may be electrically connected to another cylindrical secondary battery adjacent thereto via a busbar. The busbar may be in contact with and may be coupled to the terminal 150 or the case 110 of the cylindrical secondary battery 100. The upper surface of the cylindrical secondary battery 100 may have a flat shape due to the upper terminal 152 coupled to the upper side of the lower terminal 151 having the terminal recess 151x, whereby welding between the cylindrical secondary battery 100 and the busbar may be easily performed.

As is apparent from the above description, in a cylindrical secondary battery, according to various embodiments of the present disclosure, the compression rate at which a pressing portion of a lower terminal presses a pressing insulating member interposed between a case and a terminal may be adjusted, whereby it is possible to prevent damage due to excessive pressing or leakage due to non-pressing and to facilitate sealing between the case and the terminal.

In the cylindrical secondary battery according to the various embodiments of the present disclosure, the terminal and a current collector plate may be welded to each other outside the case through a terminal recess provided in the terminal, whereby it is possible to prevent welding debris from being generated in the case and to prevent an electrode assembly from being damaged by welding heat.

In the cylindrical secondary battery according to the various embodiments of the present disclosure, the current collector plate and the terminal may be welded to each other in the terminal recess of the terminal. Consequently, a weld bead may be located in the terminal recess, and therefore, it is possible to prevent protrusion of the terminal caused by the weld bead being located on top of the terminal.

In the cylindrical secondary battery according to the various embodiments of the present disclosure, the terminal recess provided in the lower terminal may be filled with an upper terminal (e.g., partially or fully filled), whereby an upper surface of a terminal may be approximately flat. Consequently, it is possible to prevent poor welding due to misalignment that may be caused by the terminal recess or to prevent an increase in resistance due to insufficient welding area while a plurality of secondary batteries is welded to each other via a busbar.

The above are only exemplary embodiments for implementing a cylindrical secondary battery according to the present disclosure. The present disclosure is not limited to the above embodiments, and a person having ordinary skill in the art to which the present disclosure pertains will recognize the technical spirit of the present disclosure to the extent that various modifications can be made without departing from the gist of the present disclosure as claimed in the following claims.

What is claimed is:

1. A cylindrical secondary battery comprising:
an electrode assembly having a first electrode plate, a separator, and a second electrode plate;
a case configured to receive the electrode assembly, wherein a lower end of the case is open, the case being electrically connected to the second electrode plate;
a first current collector plate interposed between an upper surface of the electrode assembly and the case, the first current collector plate being electrically connected to the first electrode plate;
a terminal extending through an upper surface portion of the case, the terminal having a lower end electrically and mechanically coupled to an upper surface of the first current collector plate; and
a cap plate configured to seal the lower end of the case, wherein:
the terminal comprises a head located above the upper surface portion of the case, a fastening portion extending through the case, and a pressing portion located under the upper surface portion of the case, and
the pressing portion is bent about a bent portion and pressed in a state of overlapping in a form of two layers.

2. The cylindrical secondary battery as claimed in claim 1, wherein the pressing portion has a plurality of corrugations extending from a center in which the fastening portion is located to the bent portion.

3. The cylindrical secondary battery as claimed in claim 2, wherein the pressing portion is bent to have corrugations of a uniform thickness, and a distance between the corrugations is constant.

4. The cylindrical secondary battery as claimed in claim 2, wherein the pressing portion has 40 to 50 pitches, which corresponds to a number of the plurality of corrugations.

5. The cylindrical secondary battery as claimed in claim 2, wherein a corrugation width of the pressing portion, which is a width between a high point and a low point of the corrugation, is a same value as a thickness of the fastening portion.

6. The cylindrical secondary battery as claimed in claim 2, further comprising a shaping portion located under the pressing portion, the shaping portion having a flat bottom plate and a side wall extending upward from an edge of the bottom plate, the side wall being coupled to a lower side of the pressing portion.

7. The cylindrical secondary battery as claimed in claim 6, wherein a corrugation width of the pressing portion, which is a width between a high point and a low point of the corrugation, is less than 50% of a thickness of the side wall of the shaping portion.

8. The cylindrical secondary battery as claimed in claim 6, wherein the side wall has a screw thread formed at an inner surface thereof.

9. The cylindrical secondary battery as claimed in claim 1, further comprising a pressing insulating member interposed between the pressing portion and the case.

10. The cylindrical secondary battery as claimed in claim 9, wherein:
the pressing insulating member extends farther outward than the pressing portion in plan, and
a region of the pressing insulating member located above the pressing portion is pressed such that a thickness of the region of the pressing insulating member located above the pressing portion is less than a thickness of a region of the pressing insulating member located outside the pressing portion.

11. The cylindrical secondary battery as claimed in claim 10, wherein the pressing insulating member is pressed by the pressing portion so as to have a compression rate of 30% to 50%.

12. The cylindrical secondary battery as claimed in claim 1, wherein the terminal further comprises:
a lower terminal provided with a terminal recess having a predetermined depth from an upper surface thereof in a downward direction, the lower terminal comprising the head located above the upper surface portion of the case, the fastening portion extending through the case, and the pressing portion located under the upper surface portion of the case; and
an upper terminal configured to fill the terminal recess of the lower terminal.

13. The cylindrical secondary battery as claimed in claim 12, wherein the first current collector plate is welded to the lower terminal through the terminal recess outside the lower terminal in a state in which an upper surface of the first current collector plate is in contact with a lower surface of the lower terminal such that a weld bead is located in the terminal recess.

14. The cylindrical secondary battery as claimed in claim 12, wherein the upper terminal comprises an approximately flat flange and a coupling portion extending downward from a center of the flange, the coupling portion having a screw thread provided at an outer surface thereof.

15. The cylindrical secondary battery as claimed in claim 14, wherein the fastening portion has a screw thread provided at an inner surface thereof, the screw thread of the fastening portion being screw-engaged with the screw thread of the coupling portion.

16. The cylindrical secondary battery as claimed in claim 14, wherein the flange of the upper terminal and an upper surface of the lower terminal are in a same plane.

17. The cylindrical secondary battery as claimed in claim 14, wherein the head of the lower terminal is provided with a ring-shaped stepped groove extending from an upper surface thereof in a downward direction, the flange of the upper terminal being inserted into and seated in the ring-shaped stepped groove.

18. The cylindrical secondary battery as claimed in claim 14, wherein a lower surface of the coupling portion is spaced apart from a lower surface of the terminal recess.

19. The cylindrical secondary battery as claimed in claim 1, further comprising a first gasket interposed between the terminal and the case.

20. The cylindrical secondary battery as claimed in claim 1, further comprising:
a second gasket interposed between the case and the cap plate, wherein the cap plate is non-polarized.
